(19) United States
(12) Patent Application Publication
(10) Pub. No.: US 2013/0192648 A1
(43) Pub. Date: Aug. 1, 2013

(54) SUBSTRATE TREATING APPARATUSES AND METHODS OF REMOVING REACTION GAS USING THE SAME

(71) Applicant: SAMSUNG ELECTRONICS CO., LTD., Suwon-si (KR)

(72) Inventors: Hyun Ho CHO, Suwon-si (KR); Donghyun KIM, Osan-si (KR); Dongyeon KIM, Hwaseong-si (KR); Yohan AHN, Yongin-si (KR); Kunhyung LEE, Hwaseong-si (KR)

(73) Assignee: SAMSUNG ELECTRONICS CO., LTD., Suwon-si (KR)

(21) Appl. No.: 13/755,367

(22) Filed: Jan. 31, 2013

(30) Foreign Application Priority Data
Feb. 1, 2012 (KR) 10-2012-0010446

(51) Int. Cl. B08B 9/093

(52) U.S. Cl. CPC B08B 9/093
USPC 134/22.1

(57) ABSTRACT

A method of removing a reaction gas remaining in a process chamber after a process of treating a substrate in the process chamber is completed includes exhausting the reaction gas remaining in the process chamber to a region outside of the process chamber through an exhaust line, and supplying a cleaning gas into the process chamber through a gas supplying line. The cleaning gas is different from the reaction gas

### CROSS-REFERENCE TO RELATED APPLICATION

This application claims priority under 35 U.S.C. §119 to Korean Patent Application No. 10-2012-0010446, filed on Feb. 1, 2012, in the Korean Intellectual Property Office, the entirety of which is incorporated by reference herein.

### BACKGROUND

Various process gases and/or various chemical solutions may be used in semiconductor manufacturing processes. For example, in a deposition process, a deposition gas may be provided into a process chamber to deposit a thin film on a surface of a substrate. In an etching process, an etching gas may be provided into a process chamber to selectively etch a non-desired region of a thin film on the surface of the substrate.

### SUMMARY

Embodiments may be realized by providing a method of removing a reaction gas remaining in a process chamber after a process of treating a substrate in the process chamber is completed, the method including exhausting the reaction gas remaining in the process chamber to a region outside of the process chamber through an exhaust line, supplying a cleaning gas into the process chamber through a gas supplying line, and the cleaning gas is different from the reaction gas.

The method may further include supplying a purge gas into the process chamber before the reaction gas remaining in the process chamber is exhausted and before the cleaning gas is supplied. Before the purge gas is supplied, a first pressure lower than an atmospheric pressure may be maintained inside the process chamber. After the purge gas is supplied, a second pressure that corresponds to the atmospheric pressure may be maintained inside the process chamber.

The cleaning gas may include air. The cleaning gas may include an inert gas. The gas supplying line may be connected to the process chamber and the gas supplying line may include an inlet in which the cleaning gas flows. The inlet may be exposed to another region outside of the process chamber. Air in the other region outside the process chamber may be drawn into the inlet such that the air is supplied into the process chamber.

Supplying the cleaning gas may include supplying a first cleaning gas, and supplying a second cleaning gas having a moisture-content lower than that of the first cleaning gas. The second cleaning gas may be supplied after the first cleaning gas. The first cleaning gas and the second cleaning gas may be alternately and repeatedly supplied. The first cleaning gas may include air, and the second cleaning gas may include an inert gas.

Embodiments may also be realized by providing a substrate treating apparatus that includes a process chamber having a space in which a substrate treating process is performed, a substrate supporting part arranged in the process chamber and supporting a substrate, a process gas supplying part that supplies a process gas into the process chamber for the substrate treating process, a vacuum applying part that keeps an inside of the process chamber in a vacuum state during the substrate treating process, a reaction gas exhaust part that exhausts a reaction gas remaining in the process chamber to a region outside of the process chamber, a cleaning gas supplying part that supplies a cleaning gas into the process chamber and the cleaning gas is different from the process gas, and a controller that controls the reaction gas exhaust part and the cleaning gas supplying part such that after the substrate treating process is performed the reaction gas is exhausted to the region outside of the process chamber and the cleaning gas is supplied into the process chamber at a same time.

The cleaning gas supplying part may include a gas supplying line connected to the process chamber and a valve at the gas supplying line. The gas supplying line may be an inlet into which the cleaning gas flows. The inlet may be formed toward another region outside of the process chamber. The valve may open and close the gas supplying line. The cleaning gas may include an inert gas.

The cleaning gas supplying part may include a first cleaning gas supplying part that supplies a first cleaning gas, and a second cleaning gas supplying part that supplies a second cleaning gas having a moisture-content lower than that of the first cleaning gas. The controller may control the first and second cleaning gas supplying parts such that the first cleaning gas and the second cleaning gas are sequentially supplied. The controller may control the first and second cleaning gas supplying parts such that the first cleaning gas and the second cleaning gas are sequentially and repeatedly supplied.

The process chamber may include a treating room providing a space in which the substrate treating process is performed, a heating member heating the treating room, and a load lock chamber under the treating room, the load lock chamber including another space connected to the space of the treating room. The substrate supporting part may include a boat in which the substrate is loaded, the substrate including a plurality of substrates, the boat being capable of moving the substrates loaded in the boat, and a boat driving part that moves the boat between the treating room and the load lock chamber. The vacuum applying part may include a vacuum applying line connected to the treating room and applying a vacuum pressure to the treating room, a vacuum pump installed at the vacuum applying line, and a vacuum applying valve installed at the vacuum applying line in a section between the treating room and the vacuum pump. The reaction gas exhaust part may include a reaction gas exhaust line connected to the vacuum applying line in a section between the treating room and the vacuum applying valve, an exhaust pump installed at the reaction gas exhaust line, an exhaust line opening/closing valve installed at the reaction gas exhaust line in another section between the vacuum applying line and the exhaust pump, the exhaust line opening/closing valve opens and closes the reaction gas exhaust line, and the vacuum applying valve and the exhaust line opening/closing valve are selectively opened. The cleaning gas supplying part may include a gas supplying line connected to the process chamber and including an inlet into which the cleaning gas flows, the inlet being formed toward another region outside of the process chamber, and a valve installed at the gas supplying line, the valve opening and closing the gas supplying line.

Embodiments may also be realized by providing a method of removing a reaction gas from a process chamber, the reaction gas being within the process chamber during a process of treating a substrate in the process chamber and the reaction gas being removed from the process chamber after the process of treating the substrate is completed, the method including setting a pressure inside the process chamber as an atmospheric pressure, exhausting the reaction gas from the process chamber through an exhaust line, after setting the pressure inside the process chamber, and simultaneously with exhausting the reaction gas, supplying a cleaning gas into the process chamber through a gas supplying line, the cleaning gas being different from the reaction gas.

Setting the pressure inside the process chamber may include supplying a purge gas into the process chamber. Before the purge gas is supplied, a first pressure lower than the atmospheric pressure may be maintained inside the process chamber. After the purge gas is supplied, a second pressure that corresponds to the atmospheric pressure may be maintained inside the process chamber. Supplying the cleaning gas into the process chamber may include supplying a first cleaning gas that includes air, and separately supplying a second cleaning gas after supplying the first cleaning gas. The second cleaning gas may include an inert gas and have a moisture-content lower than that of the first cleaning gas. The first cleaning gas and the second cleaning gas may be alternately and repeatedly supplied.

Embodiments may also be realized by providing a method of cleaning a process chamber that includes removing a reaction gas from a process chamber, and after removing the reaction gas, opening the process chamber to clean an inside of the process chamber. The reaction gas is within the process chamber during a process of treating a substrate in the process chamber and the reaction gas being removed from the process chamber after the process of treating the substrate is completed. Removing the reaction gas includes setting a pressure inside the process chamber as an atmospheric pressure, exhausting the reaction gas from the process chamber through an exhaust line, after setting the pressure inside the process chamber, and simultaneously with exhausting the reaction gas, supplying a cleaning gas into the process chamber through a gas supplying line, the cleaning gas being different from the reaction gas

### BRIEF DESCRIPTION OF THE DRAWINGS

Features will become apparent to those of ordinary skill in the art by describing in detail exemplary embodiments with reference to the attached drawings in which:

FIG. 1 illustrates a schematic view of a substrate treating apparatus according to an exemplary embodiment;

FIG. 2 illustrates a flow chart of a process treating method according to an exemplary embodiment;

FIG. 3 illustrates a graph of concentration variation of a reaction gas in a process chamber according to first experimental results;

FIG. 4 illustrates a graph of concentration variation of a reaction gas in a process chamber according to second experimental results; and

FIG. 5 illustrates a schematic view of a substrate treating apparatus according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. The same reference numerals or the same reference designators denote the same elements throughout the specification. It will also be understood that when an element is referred to as being “on” another element, it can be directly on the other element, or intervening elements may also be present. Further, it will be understood that when a layer is referred to as being “under” another element, it can be directly under, and one or more intervening elements may also be present. In addition, it will also be understood that when an element is referred to as being “between” two elements, it can be the only element between the two elements, or one or more intervening elements may also be present. In contrast, the term “directly” means that there are no intervening elements.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings. Exemplary embodiments of aspects explained and illustrated herein include their complementary counterparts.

The embodiments in the detailed description will be described with sectional views as exemplary views. Therefore, the embodiments are not limited to the specific shape illustrated in the exemplary views, but may include other shapes that may be created. Areas exemplified in the drawings have general properties, and are used to illustrate specific shapes of elements. Further, exemplary embodiments should not be construed as limited to the shapes of regions illustrated herein but are to include deviations in shapes that result, e.g., from manufacturing.

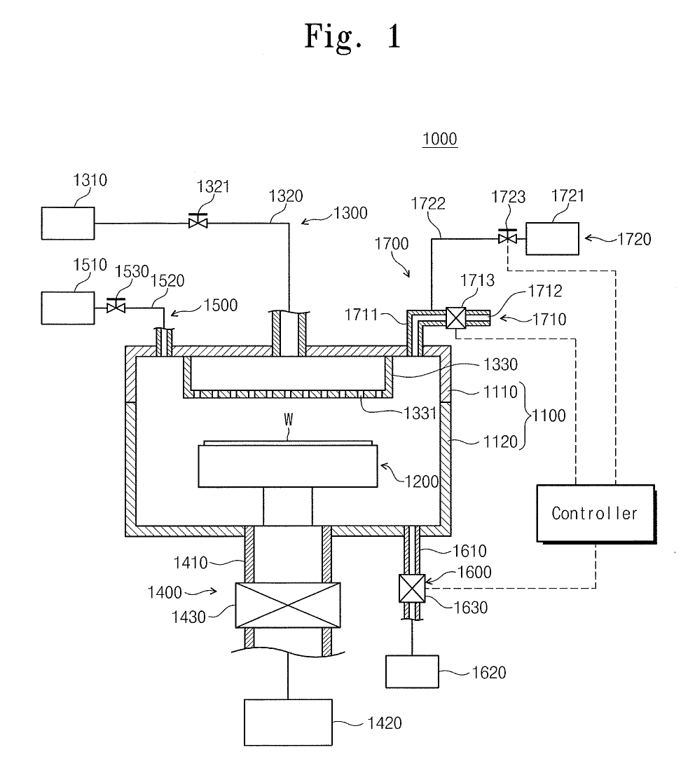

FIG. 1 is a schematic view illustrating a substrate treating apparatus according to an exemplary embodiment.

Referring to FIG. 1, a substrate treating apparatus 1000 may perform various processes for manufacturing a semiconductor device. Hereinafter, the substrate treating apparatus 1000 performing a deposition process of depositing a thin film on a surface of a substrate W will be described as an example. However, embodiments are not limited thereto. For example, the substrate treating apparatus 1000 may be used for a process treating a substrate in vacuum by using a process gas, e.g., a diffusion process, an etching process, and/or an ashing process. The substrate treating apparatus 1000 may perform a chemical vapor deposition (CVD) process.

The substrate treating apparatus 1000 may include a process chamber 1100, a substrate supporting part 1200, a process gas supplying part 1300, a vacuum applying part 1400, a purge gas supplying part 1500, a reaction gas exhaust part 1600, a cleaning gas supplying part 1700, and a controller.

The process chamber 1100 provides a space in which the substrate W is treated. The process chamber 1100 may include an upper chamber 1110 and a lower chamber 1120 combined with, e.g., directly coupled to, the upper chamber 1110. A space having an opened bottom side is formed in the upper chamber 1110 and a space having an opened top side is formed in the lower chamber 1120. The upper chamber 1110 is disposed on a top end of the lower chamber 1120. The inside of the upper chamber 1110 is combined with the inside of the lower chamber 1120, thereby forming the space in which the substrate W is treated. If the process treating the substrate W is repeatedly performed in the substrate treating apparatus 1000 during a predetermined time, a reaction by-product and/or remaining process gases may be cumulated within the process chamber 1100.

The upper chamber 1110 may be capable of separating from the lower chamber 1120, so that the space may be opened. A worker may open the upper chamber 1110, e.g., to remove the reaction by-product or replace parts provided in the process chamber 1100 with new parts. Further, the worker may clean various devices of the substrate treating apparatus 1000.

An opening (not shown) may be formed at a sidewall of the process chamber 1100. The substrate W is inserted into and is removed from the process chamber 1100 through the opening. The opening may be opened and closed by a shutter (not shown) installed on an outer sidewall of the process chamber 1100. The shutter opens the opening when the substrate W is inserted into and removed from the process chamber 1100. The shutter closes the opening while the substrate W is treated in the process chamber 1100, so that it is possible to reduce the possibility of and/or prevent a process gas from leaking outside the process chamber 1100.

The substrate supporting part 1200 is located within the process chamber 1100. For example, the substrate support part 1200 may be housed, e.g., entirely housed, within the lower chamber 1120. The substrate supporting part 1200 may support the substrate W, e.g., the substrate W may be placed on an upper surface of the substrate supporting part 1200 through the opening in a sidewall of the process chamber 1100. According to an exemplary embodiment, the substrate supporting part 1200 may be an electrostatic chuck fixing the substrate W by an electrostatic force or a chuck instrumentally fixing the substrate W by a plurality of clamps.

A heater (not shown) may be disposed within the substrate supporting part 1200, e.g., under the surface on which the substrate W is placed. A resistance heating element may be used as the heater. The heater generates heat so as to heat the substrate W to a predetermined temperature and to maintain the predetermined temperature of the substrate W while a process is performed within the process chamber 1100.

The process gas supplying part 1300 may be attached to a side, e.g., an upper side, of the process chamber 1100. The process gas supplying part 1300 may supply a process gas into the process chamber 1100. The process gas supplying part 1300 may include a process gas storage part 1310, a process gas supplying line 1320, and a distribution plate 1330.

The process gas storage part 1310 stores the process gas therein. The process gas may be one of various gases for forming the thin layer on the surface of the substrate W. For example, the process gas may be for forming a silicon layer or a metal layer on the surface of the substrate W.

The process gas supplying line 1320 connects the process gas storage part 1310 to the process chamber 1100. Therefore, one end of the process gas supplying line 1320 is, e.g., directly, connected to the process gas storage part 1310. The process gas stored in the process gas storage part 1310 is supplied into the process chamber 1100 through the process gas supplying line 1320. A valve 1321 may be installed at a region of the process gas supplying line 1320. The valve 1321 opens and closes the process gas supplying line 1320.

The distribution plate 1330 is disposed within the process chamber 1100, e.g., so as to be directly connected to another end of the process gas supplying line 1320. The distribution plate 1330 is disposed over the substrate supporting part 1200, e.g., the distribution plate 1330 may overlap an entirety of the substrate W.

The distribution plate 1330 may be fixedly combined with a top wall, e.g., at the upper side, of the process chamber 1100. The distribution plate 1330 may be housed, e.g., entirely housed, within the upper chamber 1110. A bottom surface of the distribution plate 1330, which faces the substrate W, may have an area substantially equal to or greater than an area of the substrate W.

Spreading holes 1331 may be formed at the bottom surface of the distribution plate 1330. The spreading holes 1331 may be arranged in a pattern, e.g., uniformly formed, at the bottom surface of the distribution plate 1330. The process gas supplied into the process chamber 110 may be spread through the spreading holes 1331, so that the process gas is uniformly supplied to the substrate W.

The vacuum applying part 1400 may apply a vacuum pressure within the process chamber 1100. The vacuum applying part 1400 may be connected to a side, e.g., a lower side, of the process chamber 1100. For example, the vacuum applying part 1400 may be connected to the process chamber 1100 in a region under the substrate supporting part 1200. The vacuum applying part 1400 may include a vacuum applying line 1410, a vacuum pump 1420, and a vacuum applying valve 1430.

The vacuum applying line 1410 may be connected to a bottom wall of the process chamber 1100, e.g., directly connected to a bottom wall of the lower chamber 1120. The vacuum pump 1420 may be installed at, e.g., directly coupled to, the vacuum applying line 1410. The vacuum applying valve 1430 may be installed at the vacuum applying line 1410. The vacuum applying valve 1430 may open and close the vacuum applying line 1410. The vacuum applying valve 1430 may be opened while the treating process is performed in the process chamber 1100 so that the treating process may be performed in vacuum.

The vacuum pressure may be applied in the process chamber 1100 by driving the vacuum pump 1420. The vacuum pressure decompresses in the process chamber 1100, so that the inside of the process chamber 110 may be substantially in a vacuum state. A reaction gas that includes, e.g., the reaction by-product generated and a process gas supplied during the treating process, may be exhausted outside the process chamber 1100 through the vacuum applying line 1410. The reaction gas means a gas remaining in the process chamber 1100 as a result of the treating process, e.g., the reaction gas may remain in the process chamber 1100 during the treating process and/or after the treating process is completed.

When the treating process is finished, the vacuum applying valve 1430 keeps the vacuum applying line 1410 in a closed state. For example, the vacuum applying line 1410 may be changed to the closed state after the treating process is completed and may be changed to the opened state when a new treating process is started.

The purge gas supplying part 1500 supplies a purge gas into the process chamber 1100. The purge gas supplying part 1500 may be connected to a side of the process chamber 1100, e.g., may be directly connected to the upper side of the process chamber 1100. The purge gas supplying part 1500 includes a purge gas storage part 1510, a purge gas supplying line 1520, and a purge gas supplying valve 1530.

The purge gas storage part 1510 stores the purge gas. The purge gas may include an inert gas. The purge gas supplying line 1520 may connect the purge gas storage part 1510 to the process chamber 1100. The purge gas supplying valve 1530 may be installed at a region of the purge gas supplying line 1520. The purge gas supplying valve 1530 may open and close the purge gas supplying line 1520. For example, after the treating process for the substrate W is completed, the purge gas may be supplied into the process chamber 1100 in a small amount. The inner pressure of the process chamber 1100 may be raised to atmospheric pressure by the supplying of the purge gas.

According to an exemplary embodiment, when the purge gas supplying valve 1530 is opened, the vacuum applying valve 1430 may be closed. Further the purge gas may be supplied, in the small amount, until atmospheric pressure is reached and the purge gas supplying valve 1530 may be closed thereafter.

The reaction gas exhaust part 1600 exhausts the reaction gas remaining in the process chamber 1100. The reaction gas exhaust part 1600 may be connected to a side, e.g., the lower side, of the process chamber 1100. The reaction gas exhaust part 1600 may include a reaction gas exhaust line 1610, an exhaust pump 1620, and an exhaust line opening/closing valve 1630.

The reaction gas exhaust line 1610 may be connected, e.g., directly connected, to the process chamber 1100. The reaction gas exhaust line 1610 may have a diameter smaller than that of the vacuum applying line 1410. The exhaust pump 1620 may be installed at a region of the reaction gas exhaust line 1610. The exhaust line opening/closing valve 1630 may be installed at a section between the process chamber 1100 and the exhaust pump 1620. The exhaust line opening/closing valve 1630 may open and close the reaction gas exhaust line 1610.

After the substrate W is treated, the reaction gas exhaust part 1600 may be used to exhaust the reaction gas to an outside of the process chamber 1100 in the state that the atmospheric pressure is maintained as the inner pressure of the process chamber 1100. For example, atmospheric pressure may be maintained in the process chamber 1100 while the reaction gas is exhausted to the outside through the reaction gas exhaust part 1600 based on, e.g., supplying other gases to the process chamber. The reaction gas remaining in the process chamber 1100 may be exhausted to the outside of the process chamber 1100 through the reaction gas exhaust line 1610 by opening the exhaust line opening/closing valve 1630 and driving the exhaust pump 1620. The reaction gas may be exhausted to the outside after the treating process of the substrate W is completed and after the purge gas has been supplied to the process chamber 1100.

The cleaning gas supplying part 1700 may supply a cleaning gas into the process chamber 1100. The cleaning gas reacts with the process gas remaining in the process chamber 1100 and is exhausted outside the process chamber 1100 through the reaction gas exhaust line 1610. In some embodiments, the cleaning gas supplying part 1700 may include a first cleaning gas supplying part 1710 and a second cleaning gas supplying part 1720. The first cleaning gas supplying part 1710 may supply a first cleaning gas into the process chamber 1100. The first cleaning gas may include air. The first cleaning gas supplying part 1710 may include a first cleaning gas supplying line 1711 and a first valve 1713.

A first end of the first cleaning gas supplying line 1711 may be connected to the process chamber 1100, e.g., may be directly connected to the upper side of the process chamber 1100. A second end of the first cleaning gas supplying line 1711 may be located outside the process chamber 1100, e.g., and may be connected to the first cleaning gas supplying part 1710. An inlet 1712 may be formed at the second end of the first cleaning gas supplying line 1711. According to an exemplary embodiment, the inlet 1712 may be exposed in the outside of the process chamber 1100 and may be formed so as to be exposed toward the atmosphere. The first valve 1713 may be installed at a region of the first cleaning gas supplying line 1711. The first valve 1713 opens and closes the first cleaning gas supplying line 1711.

The second cleaning gas supplying part 1720 may supply a second cleaning gas into the process chamber 1100, e.g., via a portion of the first cleaning gas supplying line 1711. The second cleaning gas supplying part 1720 may include a second cleaning gas storage part 1721, a second cleaning gas supplying line 1722, and a second valve 1723. The second cleaning gas storage part 1721 stores the second cleaning gas. The second cleaning gas may have a moisture-content lower than that of the first cleaning gas. The second cleaning gas may include an inert gas. The second cleaning gas supplying line 1722 may be connected to the second cleaning gas storage part 1721 and the first cleaning gas supplying line 1711. The second cleaning gas supplying line 1722 may be connected to the first cleaning gas supplying line 1711 in a section between the first valve 1713 and the process chamber 1100. Alternatively, the second cleaning gas supplying line 1722 may connect the second cleaning gas storage part 1721 to the process chamber 1100. The second valve 1723 may be installed at the second cleaning gas supplying line 1722. The second valve 1723 may open and close the second cleaning gas supplying line 1722.

The controller may control the reaction gas exhaust part 1600 and the cleaning gas supplying part 1700. For example, the controller may be connected to the exhaust line opening/closing valve 1630, the first valve 1713 of the first cleaning gas supplying part 1710, and the second valve 1723 of the second cleaning gas storage part 1721. After the substrate W is treated, the controller may control the reaction gas exhaust part 1600 and the cleaning gas supplying part 1700 so that the reaction gas is exhausted to the outside the process chamber 1100 and the cleaning gases are supplied into the process chamber 1100 at the same time.

Additionally, the controller may control the first and second cleaning gas supplying parts 1710 and 1720. The controller controls the first and second cleaning gas supplying parts 1710 and 1720 so that the first cleaning gas is first supplied into the process chamber 1100 and then the second cleaning gas is second supplied into the process chamber 1100. For example, if a negative pressure is generated in the process chamber 1100 by the exhausting of the reaction gas, the controller opens the first valve 1713. Air in the atmosphere flows into the process chamber 1100 through the first cleaning gas supplying line 1710 by the negative pressure generated in the process chamber 1100. When the air flows for a predetermined time, the controller closes the first valve 1713 and opens the second valve 1723. The inert gas flows into the process chamber 1100 by opening the second valve 1723. The controller may control the first and second valves 1713 and 1713 in order that the air and the inert gas are alternately and repeatedly supplied into the process chamber 1100. The controller may control the first and second valves 1713 and 1713 so as not to be concurrently supplied into the process chamber 1100. The sequential supply of the air and the inert gas may be performed in plural.

Hereinafter, a method of treating the substrate W using the substrate treating apparatus will be described. And a method of removing the reaction gas remaining in the process chamber 1100 after treating the substrate W will be described.

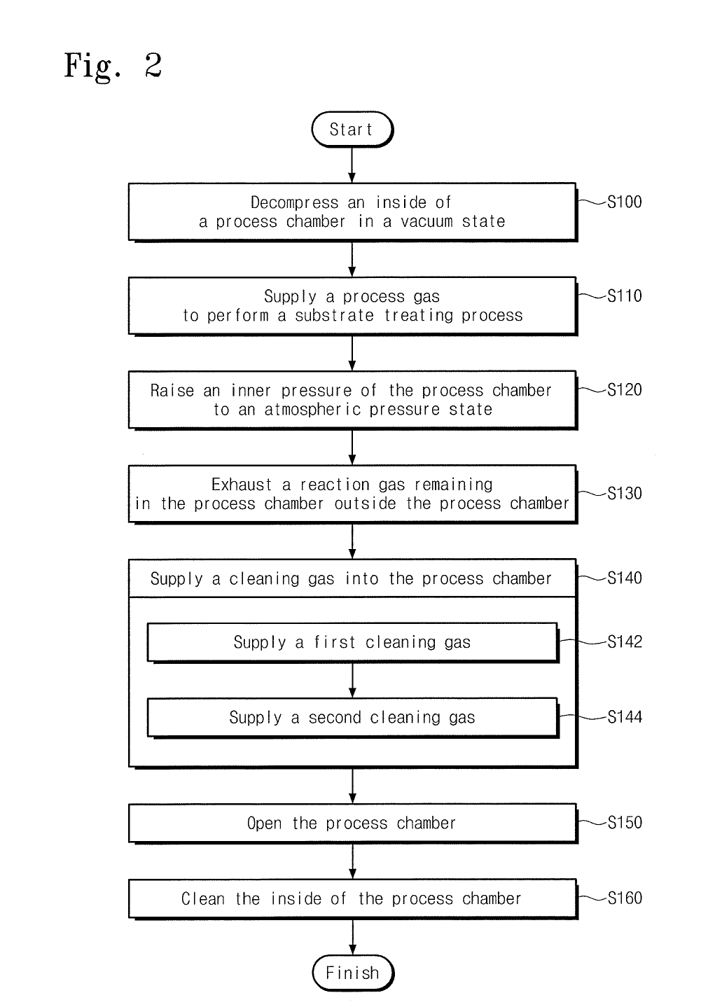

FIG. 2 is a flow chart illustrating a process treating method according to an exemplary embodiment. Referring to FIGS. 1 and 2, the substrate W is transferred into the process chamber 110 through the opening and then is set on the substrate supporting part 1200. The vacuum applying valve 1430 is opened and the vacuum pump 1420 is driven. Thus, the inside of the process chamber 1100 is decompressed in a vacuum state (S100). While in the vacuum state, the valve 1321 of the process gas supplying part 1300 is opened and the process gas is supplied into the process chamber 1100 through the process gas supplying line 1320 (S 110). At this time, the purge gas supplying valve 1530, the exhaust line closing/opening valve 1630, the first valve 1713, and the second valve 1723 are interrupted, e.g., in a closed state.

The process gas is supplied on the substrate W (S 110) to deposit a thin film on the substrate W. A gas generated by way of the process gas and the deposition process remains as the reaction gas in the process chamber 1100. The process is repeated, so that a reaction by-product may be cumulated in the process chamber 110, e.g., as residue. Since the cumulated reaction by-product is provided as a contamination source contaminating the substrate W, a cleaning process cleaning internal elements of the process chamber 1100 may be sought.

During the process of cleaning residue/contaminates in the process chamber 1100, the process chamber 1100 may be opened and then the internal elements may be replaced with new elements or cleaned. However, in the case that the gas (e.g. tungsten hexafluoride (WF₆), nitrogen trifluoride (NF₃), hydrogen chloride (HCl), etc.) used as the process gas corresponds to a toxic material noxious to the human body, a process for removing the remaining gas in the process chamber 1100 is sought before the process chamber 1100 is opened. Hereinafter, the method of removing the gas remaining in the process chamber 1100, before opening the processing chamber 1100, will be described.

First, the vacuum applying valve 1430 is closed to interrupt the vacuum applied into the process chamber 1100. And then the purge gas supplying valve 1530 is opened to supply the purge gas into the process chamber in a small amount. Due to the applying of the purge gas, the inner pressure of the process chamber 1100 is raised to maintain an atmosphere state (S120).

Then, the exhaust line closing/opening valve 1630 is opened to exhaust the reaction gas remaining in the process chamber 1100 to the outside of the process chamber 1100 (S130). The exhaust line closing/opening valve 1630 may be opened after the purge gas supplying valve 1530 is closed. The negative pressure is generated in the process chamber 1100 by exhausting the reaction gas. At the same time, the cleaning gas is supplied into the process chamber 1100 (S140). The first valve 1713 is opened, so that an external air of the process chamber 1100 flows into the process chamber 1100 through the first cleaning gas supplying line 1711 by the negative pressure generated in the process chamber 1100 (S 142). The air may include moisture of about 45% at a room temperature. The moisture in the air reacts with the reaction gas. For example, WF₆, NF₃, and HCl included in the reaction gas chemically reacts with the moisture to form HF or HCl. The gas reacting with the moisture is exhausted through the reaction gas exhaust line 1610.

After the air has been supplied for a predetermined time, the first valve 1713 is closed. And then the second valve 1723 is opened to supply the inert gas into the process chamber 1100 (S 144). The inert gas forcefully exhausts the reaction gas remaining in the process chamber 1100 to the outside the process chamber 1100. In addition, the inert gas dries out the gas reacting with the moisture in the process chamber 1100. The inert gas and the dried-out gas are exhausted to the outside the process chamber 1100 through the reaction gas exhaust line 1610. The toxic material in the process chamber 1100 may be removed by the above processes. The first valve 1713 and the second valve 1723 may be alternately and repeatedly opened and closed to remove the toxic material in the process chamber 1100.

In the method of removing the reaction gas described above, the exhaust of the reaction gas and the applying of the cleaning gas may be performed in the state that the inner pressure of the process chamber 1100 is at the atmospheric pressure (about 760 Torr). Thus, the pressure corresponding to the atmospheric pressure is maintained in the inner pressure of the process chamber 1100 during the removal of the reaction gas remaining in the process chamber 1100. Since a gas density in the atmospheric pressure is about 760 times or more than that of the vacuum state (about 1 Torr), collision and reaction probability between the reaction gas and the cleaning gas may increase. Thus, the moisture in the air smoothly reacts with the toxic material remaining on surfaces of the inner elements, such that the removal efficiency of the toxic material may be increased.

If a concentration of the reaction gas detected in the process chamber 1100 is equal to or less than a predetermined set value, a worker may open the process chamber 1100 (S 150) and then perform replacement of the inner elements and cleaning (S 160) of the surface of the process chamber 1100.

Experimental examples are provided in order to highlight characteristics of one or more embodiments, but it will be understood that the experimental examples are not to be construed as limiting the scope of the embodiments. Further, it will be understood that the embodiments are not limited to the particular details described in the experimental examples.

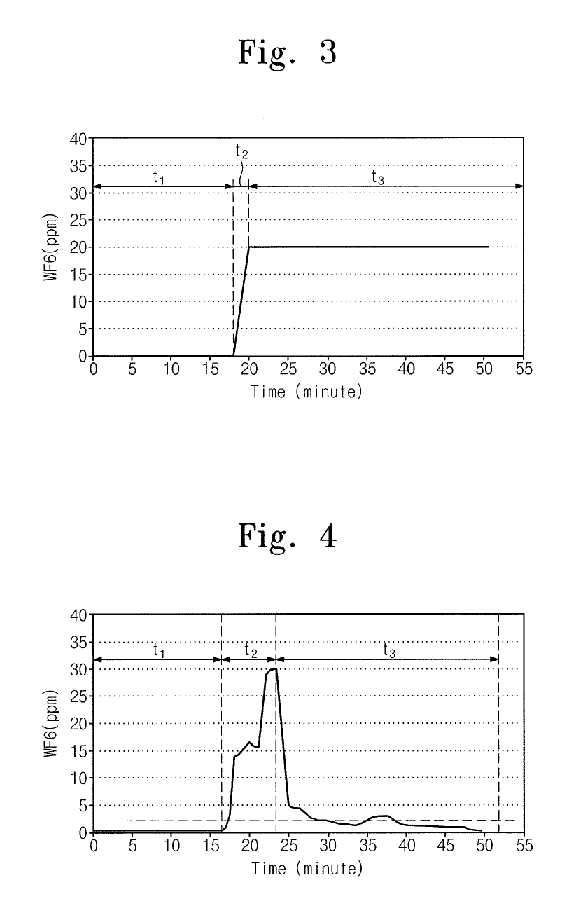

FIG. 3 is a graph illustrating concentration variation of a reaction gas in a process chamber according to a first experimental example.

Referring to FIGS. 1 and 3, a horizontal axis represents a time and a perpendicular axis represents a concentration of the reaction gas detected in the process chamber 1100 in the graph of FIG. 3. In the first experimental example, the cleaning gas was not supplied into the process chamber 1100. A concentration of a WF₆ gas as the concentration of the reaction gas was detected. The vacuum pressure is maintained within the process chamber 1100 in a section t1 between 0 minute and 17 minutes. It is may be difficult to detect the concentration of the WF₆ gas when the process chamber 1100 is at the vacuum pressure. The purge gas was supplied into the process chamber 110 in a section t2 between 17 minutes and 20 minutes. The inner pressure of the process chamber 1100 is raised from the vacuum pressure to the atmospheric pressure. In this process, the concentration of the WF₆ gas rapidly increases to 20 ppm. The reaction gas remaining in the process chamber 1100 is exhausted outside the process chamber 1100 through the reaction gas exhaust line 1610. Even though the reaction gas is exhausted, the concentration of the WF₆ gas of 20 ppm is maintained in a section t3 after 20 minutes.

FIG. 4 is a graph illustrating concentration variation of a reaction gas in a process chamber according to a second experimental example.

Referring to FIGS. 1 and 4, in the second experimental example, the cleaning gas was supplied into the process chamber 1100, which is different from the first experimental example. The vacuum pressure is maintained within the process chamber 1100 in a section t1 between 0 minute and 18 minutes. The purge gas was supplied into the process chamber 110 in a section t2 between 18 minutes and 23 minutes. The inner pressure of the process chamber 1100 is raised to the atmospheric pressure. Then, the gas in the process chamber 1100 was exhausted outside the process chamber 1100 by opening the exhaust line opening/closing valve 1630. The air flowed into the process chamber 1100.

In this process, the concentration of the WF₆ gas initially increased to 30 ppm. The WF₆ gas chemically reacted with the moisture of the air to form HF. The air was supplied for about 5 minutes. The supplying of the air was interrupted and the inert gas was supplied at about 23 minutes of the experiment time. The inert gas forcefully exhausts the reaction gas remaining in the process chamber 1100 to the outside of the process chamber 1100. And the inert gas dries out the gas reacting with the moisture in the process chamber 1100. For this process, the concentration of the WF₆ gas remaining in the process chamber 1100 was rapidly reduced. The WF₆ gas of a very small amount was detected after about 25 minutes from the time the applying of the inert gas started.

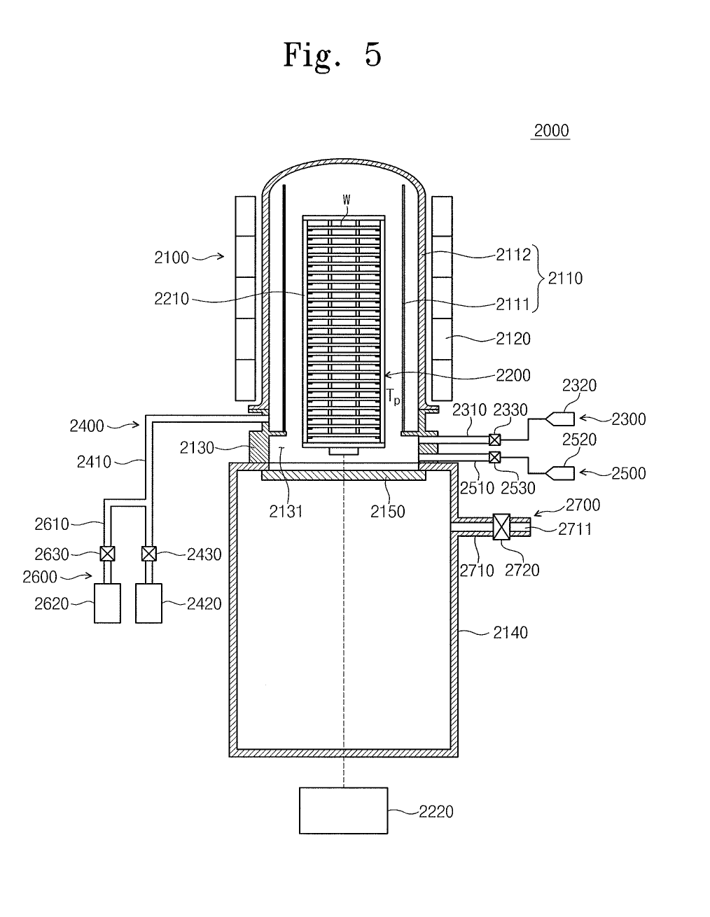

FIG. 5 is a schematic view illustrating a substrate treating apparatus according to another exemplary embodiment.

Referring to FIG. 5, a substrate treating apparatus 2000 may include a process chamber 2100, a substrate supporting part 2200, a process gas supplying part 2300, a vacuum applying part 2400, a purge gas supplying part 2500, a reaction gas exhaust part 2600, a cleaning gas supplying part 2700, and a controller.

The process chamber 2100 provides a space in which, e.g., a diffusion process or a deposition process, may be performed on a substrate W. The process chamber 2100 includes a treating room 2110, a heating member 2120, a flange 2130, a load lock chamber 2140, and a shutter 2150.

The treating room 2110 may consist of an inner tube 2111 and an outer tube 2112 that are formed of, e.g., quartz. The inner tube 2111 may have a cylinder-shape of which a top side and a bottom side are opened. The bottom side of the inner tube 2111 may be seated on the flange 2130. The outer tube 2112 may include a sidewall part and an upper part. The sidewall part of the outer tube 2112 may have a cylinder-shape of which a bottom side is opened and the upper part of the outer tube 2112 may have a dome-shape. The sidewall part of the outer tube 2112 may be arranged in parallel with the inner tube 2111 and may be seated on the flange 2130. The outer tube 2112 may surround the inner tube 2111 and may be spaced apart from the inner tube 2111 by a predetermined distance.

The heating member 2120 may be disposed to surround the outer tube 2112. The heating member 2120 heats the insides of the outer and inner tubes 2112 and 2111 to a process temperature. The process temperature may have a range of about 600 degrees Celsius and about 900 degrees Celsius. The inner tube 2111 and the outer tube 2112 may be supported by the flange 2130. A hole 2131 may be formed at a center of the flange 2130. The inside of the treating room 2110 may be connected to the inside of the load lock chamber 2140 through the hole 2131. The flange 2130 may have a cylinder-shape of which a top side and a bottom side are opened. The flange 2130 may have a radius corresponding to a radius of the outer tube 2112.

The load lock chamber 2140 may be located under the flange 2130. The load lock chamber 2140 provides a space in which the substrate W is received in a boat 2210 or is picked up from the boat 2210. The shutter 2150 may be installed in an inner region of the load lock chamber 2140 adjacent to the flange 2130. The shutter 2150 opens and closes the hole 2131 of the flange 2130. The shutter 2150 opens the hole 2131 of the flange 2130 when the boat 2210 is moved between the treating room 2110 and the load lock chamber 2140.

The substrate supporting part 2200 supports the substrate W in the process chamber 2100. The substrate supporting part 2200 include the boat 2210 and a boat driving part 2220. A plurality of the substrates W may be vertically stacked on and/or within the boat 2210 and the boat 2210 supports the plurality of the substrates W. The boat driving part 2220 linearly moves the boat 2210 in an up direction or a down direction so that the boat 2210 is movable between the treating room 2110 and the load lock chamber 2140.

The process gas supplying part 2300 supplies a process gas into the treating room 2110, e.g., through an opening in the flange 2130 so as to be connected at a lower end of the treating room 2110. The process gas may oxidize the substrate W to form an oxide layer. Alternatively, the process gas may include various gases capable of forming a thin film on the substrate W. The process gas supplying part 2300 may include a process gas supplying line 2310, a process gas storage part 2320, and a process gas opening/closing valve 2330. The process gas supplying line 2310 connects the process gas storage part 2320 to the flange 2130 and supplies the process gas stored in the process gas storage part 2320 into the treating room 2110. The process gas supplying line 2310 may be connected to a side of the flange 2130. The process gas opening/closing valve 2330 may be installed at the process gas supplying line 2310. The process gas opening/closing valve 2330 opens and closes the process gas supplying line 2310.

The purge gas supplying part 2500 may include a purge gas supplying line 2510, a purge gas storage part 2520, and a purge gas control valve 2530. The purge gas supplying line 2510 connects the purge gas storage part 2520 to the flange 2130 and supplies the purge gas stored in the purge gas storage part 2520 into the treating room 2110. The purge gas supplying line 2510 may be connected to a side of the flange 2130. The purge gas control valve 2530 may be installed at the purge gas supplying line 2510. The purge gas control valve 2530 opens and closes the purge gas supplying line 2510.

The vacuum applying part 2400 applies a vacuum pressure in the treating room 2110. The vacuum applying part 2400 includes a vacuum applying line 2410, a vacuum pump 2420, and a vacuum applying valve 2430.

The vacuum applying line 2410 may be connected to another side of the flange 2130, e.g., opposite the purge gas supplying line 2510 and the process gas supplying line 2310. The vacuum pump 2420 may be installed at an end of the vacuum applying line 2410. The vacuum applying valve 2430 may be installed at the vacuum applying line 2410 in a section between the treating room 2110 and the vacuum pump 2420. The vacuum applying valve 2430 opens and closes the vacuum applying line 2410. The vacuum applying valve 2430 is opened while the treating process is performed in the treating room 2110. The vacuum pressure is applied in the treating room 2110 by driving the vacuum pump 2420. The vacuum pressure decompresses the inside of the treating room 2110 in a vacuum state. A reaction by-product and a reaction gas generated in the treating process may be exhausted to an outside the treating room 2110 through the vacuum applying line 2410. When the treating process is finished, the vacuum applying valve 2430 is closed.

The reaction gas exhaust part 2600 exhausts the reaction gas remaining in the treating room 2110 to the outside of the treating room 2110, e.g., after the treating process is finished. The reaction gas exhaust part 2600 may include a reaction gas exhaust line 2610, an exhaust pump 2620, and an exhaust line opening/closing valve 2630.

One end of the reaction gas exhaust line 2610 may be connected to the vacuum applying line 2410 in a section between the treating room 2110 and the vacuum applying valve 2430. The exhaust pump 2620 may be installed at the reaction gas exhaust line 2610. The exhaust line opening/closing valve 2630 may be installed at the reaction gas exhaust line 2610 in a section between the vacuum applying line 2410 and the exhaust pump 2620, e.g., as to be separated from the vacuum applying valve 2430 in order to be independently controlled. The exhaust line opening/closing valve 2630 opens and closes the reaction gas exhaust line 2610. The reaction gas remaining in the treating room 2110 may be exhausted outside the treating room 2110 through the vacuum applying line 2410 and the reaction gas exhaust line 2610 by opening of the exhaust line opening/closing valve 2630 and driving of the exhaust pump 2620.

The cleaning gas supplying part 2700 supplies a cleaning gas into the process chamber 2100. The cleaning gas may react with the process gas remaining in the treating room 2110 and then sequentially pass through the vacuum applying line 2410 and the reaction gas exhaust line 2610 so as to be exhausted outside the treating room 2110. The cleaning gas supplying part 2700 may include a cleaning gas supplying line 2710 and a valve 2720. A first end of the cleaning gas supplying line 2710 may be connected to the process chamber 2100, e.g., to a sidewall of the load lock chamber 2140, and a second end of the cleaning gas supplying line 2710 may be located outside the process chamber 2100. An inlet 2711 may be formed at the second end of the cleaning gas supplying line 2710. The inlet 2711 may be formed toward the atmosphere outside the process chamber 2100. The valve 2720 may be installed at the cleaning gas supplying line 2710. The valve 2720 opens and closes the cleaning gas supplying line 2710. Air outside the process chamber 2100 flows into the process chamber 2100 through the inlet 2711. The air is used as the cleaning gas.

After the substrate W is treated, the controller controls the reaction gas exhaust part 2600 and the cleaning gas supplying part 2700 so that the reaction gas is exhausted outside the process chamber 2100 and the cleaning gas is supplied into the process chamber 2100 at the same time. Additionally, the controller controls the purge gas supplying part 2500 and the cleaning supplying part 2700. The controller may control the valve 2720 of the cleaning gas supplying part 2700 and the purge gas control valve 2530 so that the air and the purge gas are alternately and repeatedly supplied into the process chamber 2100.

A method of treating the substrate W using the above substrate treating apparatus 2000 and a method of removing the reaction gas remaining in the treating room 2110 will be described with reference to FIG. 5 hereinafter.

Referring to FIG. 5, the substrates W are loaded in the boat 2210 and the boat driving part 2220 moves the boat 2210 into the treating room 2110. The shutter 2150 is interrupted, e.g., closed, to separate the inside of the treating room 2110 from the inside of the load lock chamber 2140. The vacuum applying valve 2430 is opened and the vacuum pump 2420 is driven, so that the inside of the treating room 2110 is decompressed in the vacuum state. At this time, the exhaust line opening/closing valve 2630 is in a closed state. If the vacuum state is maintained inside the treating room 2110, the process gas is supplied into the treating room 2110 through the process gas supplying line 2310. The process gas may be diffused into the treating room 2110 to form, e.g., an oxide layer on the substrate W. A reaction by-product and the reaction gas generated in the treating process may be exhausted to a region outside the treating room 2110 through the vacuum applying line 2410.

If the substrate treating process is finished, the shutter 2150 may be opened and then the boat driving part 2220 moves the boat 2210 into the load lock chamber 2140. The substrates W are unloaded from the boat 2210 and then are provided to a subsequent process. A gas generated in the substrate treating process remains as the reaction gas in the treating room 2110. As the substrate treating processes are repeatedly performed, the reaction by-products may be cumulated in the treating room 2110. The cumulated reaction by-products may function as a contamination source contaminating the substrate W. Thus, a cleaning process cleaning the inside of the treating room 2110 may be performed.

The cleaning process is performed as follows. The vacuum pump 2420 is stopped and the vacuum applying valve 2430 is closed. The purge gas supplying valve 2530 is opened to supply the purge gas of a small amount into the treating room 2110. The inner pressure of the treating room 2110 is raised to maintain the atmospheric pressure state due to the supplying of the purge gas for a short amount of time. When the inside of the treating room 2110 is in the atmospheric pressure state, the exhaust pump 2620 is driven and the exhaust line opening/closing valve 2630 is opened. The reaction gas remaining in the treating room 2110 sequentially passes through the vacuum applying line 2410 and the reaction gas exhaust line 2610 so as to be exhausted to a region outside of the treating room 2110.

Accordingly to an exemplary embodiment, after the inside of the treating room 2110 is in the atmospheric pressure state, the purge gas supplying valve 2530 may be closed. For example, the purge gas supplying valve 2530 may be closed before or during the opening of the exhaust line opening/closing valve 2630.

Accordingly, a negative pressure may be generated in the treating room 2110 and the load lock chamber 2140 due to the exhaust of the reaction gas. The valve 2720 of the cleaning gas supplying line 2710 is opened. Thus, the air outside of the process chamber 2100 flows into the inlet 2711 of the cleaning gas supplying lien 2710 and then is supplied into the load lock chamber 2140. The air flows into the vacuum applying line 2410 via the treating room 2110 by the negative pressure generated in the process chamber 2100. The reaction gas in the treating room 2110 chemically reacts with the moisture included in the air during the movement of the air. The gas reacting with the moisture sequentially passes through the vacuum applying line 2410 and the reaction gas exhaust line 2610 and then is exhausted outside the treating room 2110.

When the air flows for a predetermined time, the valve 2720 of the cleaning gas supplying line 2710 is closed. And the valve 2530 of the purge gas supplying line 2510 may be opened, so that the inert gas flows into the treating room 2110. The inert gas forcefully exhausts the reaction gas remaining in the treating room 2110 to the outside of the treating room 2110 and dries out the gas reacting with the moisture. The inert gas and the dried-out gas sequentially passes through the vacuum applying line 2410 and the reaction gas exhaust line 2610 and then are exhausted outside the treating room 2110. Thus, a toxic material remaining in the treating room 2110 may be removed. The air and inert gas may be alternately and repeatedly supplied. After the toxic material is removed from the treating room 2110, a worker may open the treating room 2110 and then perform a cleaning work for inner elements of the treating room 2110.

In the exemplary embodiment, the air outside the process chamber 2100 is supplied into the process chamber 2100 through the cleaning gas supplying line 2711. However embodiments are not limited thereto, e.g., the air may be stored in an additional storage part at the outside of the treating room 2100 and be supplied to the cleaning gas supplying line 2711.

Additionally, in the exemplary embodiment, the cleaning gas includes the air. However, embodiments are not limited thereto, e.g., the cleaning gas may include an inert gas. In another embodiments, a first cleaning gas include air may be provided and a second cleaning gas including an inert gas may be provided as discussed with reference to FIG. 1. In this case, the inert gas of the first cleaning gas may have a moisture-content higher than that of the inert gas of the second cleaning gas.

Further, in the exemplary embodiment, the cleaning gas supplying line 2710 is connected to the load lock chamber 2140. However, embodiments are not limited thereto, e.g., the cleaning gas supplying line 2710 may be connected to the flange 2130.

By way of summation and review, a process gas such as a deposition gas or an etching gas may be provided into a process chamber in vacuum to deposit a thin film or to etch a thin film, respectively. As processes using various process gases and/or various chemical solutions are repeatedly performed, reaction by-products may be cumulated in the process chamber. The accumulated reaction by-products may function as a contaminator. Thus, cleaning work may be performed to clean the inside of the process chamber.

In the cleaning work, a worker may remove the cumulated reaction by-products by opening the process chamber. Further, the worker may replace elements of the apparatus with new elements or clean a surface of the apparatus. However, a reaction gas remaining in the process chamber, which may include a process gas such as tungsten hexafluoride (WF6), nitrogen trifluoride (NF3), and hydrogen chloride (HCl), may correspond to toxic materials that are harmful to a human body. Accordingly, in the event that toxic gasses are spread outside the process chamber, the health of the worker may be compromised.

In contrast, embodiments relate to substrate treating apparatuses and methods of removing reaction gas using the substrate treating apparatuses in which the worker may be protected from exposure to a toxic gas. For example, embodiments relate to a substrate treating apparatus capable of effectively removing a reaction gas remaining in the process chamber before the process chamber is opened. Embodiments also relate to a method of effectively removing a reaction gas remaining in a process chamber before the process chamber is opened. Thus, the working environment of the worker may be improved.

Further, embodiments relate to the reaction gas remaining in the process chamber being effectively removed by supplying the cleaning gas. Embodiments also relate to the process chamber being opened after the reaction gas in the process chamber is removed so that the worker may be protected from exposure to the toxic gas.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A method of removing a reaction gas remaining in a process chamber after a process of treating a substrate in the process chamber is completed, the method comprising:
exhausting the reaction gas remaining in the process chamber to a region outside of the process chamber through an exhaust line; and
supplying a cleaning gas into the process chamber through a gas supplying line, the cleaning gas being different from the reaction gas.

2. The method as claimed in claim 1, further comprising supplying a purge gas into the process chamber before the reaction gas remaining in the process chamber is exhausted and before the cleaning gas is supplied, wherein:
before the purge gas is supplied, a first pressure lower than an atmospheric pressure is maintained inside the process chamber, and
after the purge gas is supplied, a second pressure that corresponds to the atmospheric pressure is maintained inside the process chamber.

3. The method as claimed in claim 1, wherein the cleaning gas includes air.

4. The method as claimed in claim 3, wherein:
the gas supplying line is connected to the process chamber, the gas supplying line including an inlet in which the cleaning gas flows,
the inlet being exposed to another region outside of the process chamber, and
air in the other region outside the process chamber being drawn into the inlet such that the air is supplied into the process chamber.

5. The method as claimed in claim 1, wherein the cleaning gas includes an inert gas.

6. The method as claimed in claim 1, wherein supplying the cleaning gas includes:
supplying a first cleaning gas, and
supplying a second cleaning gas having a moisture-content lower than that of the first cleaning gas, the second cleaning gas being supplied after the first cleaning gas.

7. The method as claimed in claim 6, wherein the first cleaning gas and the second cleaning gas are alternately and repeatedly supplied.

8. The method as claimed in claim 6, wherein:
the first cleaning gas includes air, and
the second cleaning gas includes an inert gas.

9.-15. (canceled)

16. A method of removing a reaction gas from a process chamber, the reaction gas being within the process chamber during a process of treating a substrate in the process chamber and the reaction gas being removed from the process chamber after the process of treating the substrate is completed, the method comprising:
setting a pressure inside the process chamber as an atmospheric pressure;
exhausting the reaction gas from the process chamber through an exhaust line, after setting the pressure inside the process chamber; and
simultaneously with exhausting the reaction gas, supplying a cleaning gas into the process chamber through a gas supplying line, the cleaning gas being different from the reaction gas.

17. The method as claimed in claim 16, wherein:
setting the pressure inside the process chamber includes supplying a purge gas into the process chamber,
before the purge gas is supplied, a first pressure lower than the atmospheric pressure is maintained inside the process chamber, and
after the purge gas is supplied, a second pressure that corresponds to the atmospheric pressure is maintained inside the process chamber.

18. The method as claimed in claim 16, wherein supplying the cleaning gas into the process chamber includes:
supplying a first cleaning gas that includes air, and
separately supplying a second cleaning gas after supplying the first cleaning gas, the second cleaning gas including an inert gas and having a moisture-content lower than that of the first cleaning gas.

19. The method as claimed in claim 18, wherein the first cleaning gas and the second cleaning gas are alternately and repeatedly supplied.

20. A method of cleaning a process chamber, the method including:
removing a reaction gas from a process chamber with the method as claimed in claim 16; and
after removing the reaction gas, opening the process chamber to clean an inside of the process chamber.
